(19) United States
(12) Patent Application Publication
(10) Pub. No.: US 2025/0077651 A1
(43) Pub. Date: Mar. 6, 2025

(54) ABNORMALITY MONITORING DEVICE, CENTER DEVICE, ABNORMALITY MONITORING METHOD, AND ABNORMALITY MONITORING PROGRAM

(71) Applicant: DENSO CORPORATION, Kariya-city (JP)

(72) Inventors: Shogo WATANABE, Kariya-city (JP); Tokuya INAGAKI, Kariya-city (JP); Ryosuke MURAKAMI, Kariya-city (JP); Tatsuro KAWAKAMI, Kariya-city (JP)

(21) Appl. No.: 18/805,604

(22) Filed: Aug. 15, 2024

(30) Foreign Application Priority Data
Sep. 4, 2023 (JP) 2023-143067

(51) Int. Cl. G06F 21/55

(52) U.S. Cl. CPC G06F 21/55; G06F 2221/034

(57) ABSTRACT

By an abnormality monitoring device, an abnormality monitoring method, a non-transitory computer-readable storage medium storing an abnormality monitoring program, an abnormality in an electronic control system mounted on a mobile object is monitored, and the abnormality is reported to a center device, a first monitoring target group, which is a set including a part of all of a monitoring target candidate in the electronic control system, is determined based on first identification information synchronized between the abnormality monitoring device and the center device, and a process is executed on the first monitoring target group to ensure security.

### CROSS REFERENCE TO RELATED APPLICATION

The present application claims the benefit of priority from Japanese Patent Application No. 2023-143067 filed on Sep. 4, 2023. The entire disclosure of the above application is incorporated herein by reference.

### TECHNICAL FIELD

The present disclosure mainly relates to a device, a method, and a program for monitoring an abnormality in an electronic control system mounted on a mobile object such as an automobile.

### BACKGROUND

In recent years, driving assistance technology and automated driving technology, such as vehicle-to-vehicle communication and roadside-to-vehicle communication, which are known as vehicle to everything (V2X), have been attracting attention. Along with this, vehicles have come to be equipped with a communication function, and vehicles are becoming more connected. Since the vehicles are equipped with communication function, a probability that a vehicle may receive a cyber attack, that is, unauthorized access is increasing. Therefore, it is necessary to analyze the cyber attack on vehicles and to construct countermeasures against the cyber attack.

For example, in a comparative example, a device determines whether a frame transmitted by an electronic control unit (ECU) is abnormal based on message authentication and predetermined rules, and reports the determination result to a vehicle monitoring server. Further, in another examples, a device includes a CAN monitoring ECU that monitors whether CAN frames flowing through a CAN are abnormal, and an Ethernet monitoring ECU that monitors whether Ethernet frames flowing through an Ethernet are abnormal. One monitoring ECU transmits the monitoring results to the other monitoring ECU, and the other monitoring ECU that receives the results changes a security-related process executed by the ECU.

### SUMMARY

By an abnormality monitoring device, an abnormality monitoring method, a non-transitory computer-readable storage medium storing an abnormality monitoring program, an abnormality in an electronic control system mounted on a mobile object is monitored, and the abnormality is reported to a center device, a first monitoring target group, which is a set including a part of all of a monitoring target candidate in the electronic control system, is determined based on first identification information synchronized between the abnormality monitoring device and the center device, and a process is executed on the first monitoring target group to ensure security.

### BRIEF DESCRIPTION OF THE DRAWINGS

FIG. 1 is an explanatory diagram illustrating the arrangement of an abnormality monitoring device according to each embodiment and the relationship with related devices.

FIG. 2 is an explanatory diagram illustrating the arrangement of an abnormality monitoring device according to each embodiment and the relationship with related devices.

FIG. 3 is an explanatory diagram for illustrating a configuration example of the electronic control system according to each embodiment.

FIG. 4 is an explanatory diagram showing contents of a security log according to each embodiment.

FIG. 5 is a block diagram showing a configuration example of the abnormality monitoring device and a center device according to the first embodiment.

FIG. 6 is an explanatory diagram showing an example of a monitoring target group list according to the first embodiment.

FIG. 7 is a flowchart illustrating the operation of the abnormality monitoring device and the center device according to the first embodiment.

FIG. 8A is an explanatory diagram showing another example of the monitoring target group list according to the first embodiment.

FIG. 8B is an explanatory diagram showing another example of the monitoring target group list according to the first embodiment.

FIG. 9 is a flowchart illustrating the operation of the abnormality monitoring device and the center device according to a second embodiment.

### DETAILED DESCRIPTION

Here, the present inventors have found the following difficulty.

In existing abnormality monitoring devices such as those examples, various abnormality detection methods and abnormality detection networks exist, but in principle, all possible monitoring candidates are monitored for each method and target. However, in recent years, the number of ECUs constituting an electronic control system has been increasing, and resources of the abnormality monitoring device may be likely to be insufficient when all of the monitoring target candidates are monitored.

Therefore, one example of the present disclosure provides an abnormality monitoring device or the like that is capable of monitoring abnormalities in an electronic control system even by an abnormality monitoring device with limited resources.

According to one example embodiment of the present disclosure, an abnormality monitoring device monitors an abnormality in an electronic control system mounted on a mobile object and reports the abnormality to a center device, and the abnormality monitoring device includes: a monitoring target group determination unit configured to determine a first monitoring target group, which is a set including a part of all of a monitoring target candidate in the electronic control system, based on first identification information synchronized between the abnormality monitoring device and the center device; and a security processing unit configured to execute a process to ensure security for the first monitoring target group.

Further, according to another example embodiment of the present disclosure, a center device is mounted outside a mobile object and receives a report from an abnormality monitoring device for monitoring an abnormality in an electronic control system mounted on the mobile object. The center device includes: a monitoring target group determination unit configured to determine a first monitoring target group, which is a set including a part of all of a monitoring target candidate in the electronic control system, based on first identification information synchronized between the abnormality monitoring device and the center device; and an attack analysis unit configured to analyze a cyber attack based on the report from the abnormality monitoring device.

According to the above-described configuration, the abnormality monitoring device and the like of the present disclosure is possible to monitor abnormalities in an electronic control system even when there are few resources available for abnormality monitoring. Further, even when sufficient resources can be allocated to abnormality monitoring, it is possible to allocate the surplus resources to other functions.

Hereinafter, embodiments of the present disclosure will be described with reference to the drawings.

### 1. Configuration as Prerequisite of Each Embodiment

### (1) Placement of Abnormality Monitoring Device and Relationship with Related Device

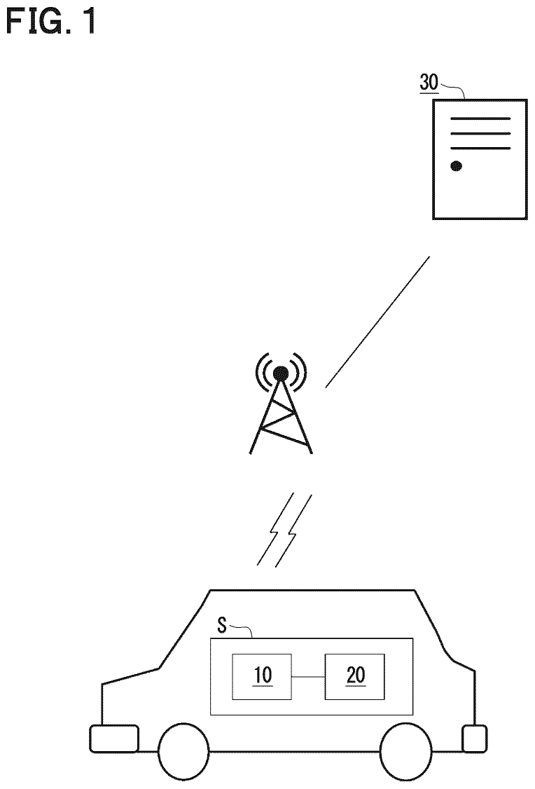

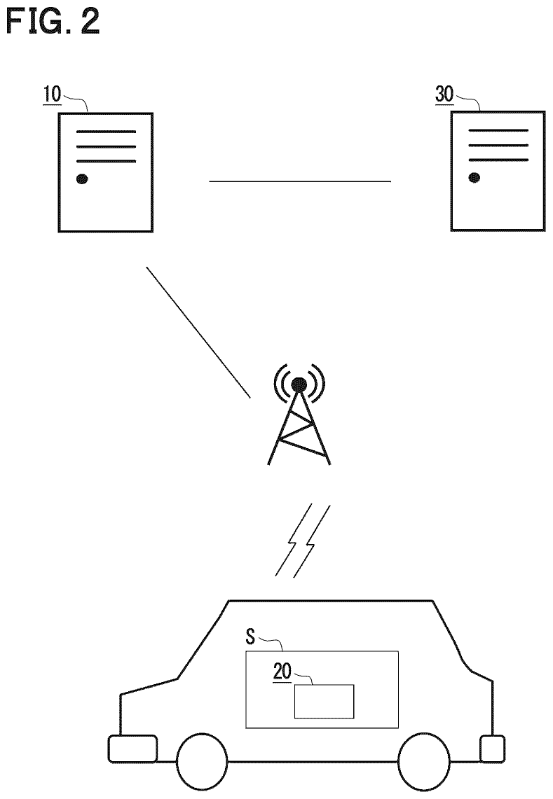

FIGS. 1 and 2 are diagrams showing a placement of an abnormality monitoring device and a relationship with a related device according to each embodiment. For example, as shown in FIG. 1, an abnormality monitoring device 10 may be mounted on a vehicle, which corresponds to a mobile object, together with an electronic control unit 20 constituting an electronic control system S. As illustrated in FIG. 2, the electronic control unit 20 constituting the electronic control system S may be mounted on a vehicle, which corresponds to a mobile object, and the abnormality monitoring device 10 may be implemented by a server device or the like disposed outside the vehicle. In each embodiment described below, a case will be described in which the abnormality monitoring device 10 is mounted on the vehicle as shown in FIG. 1. In the case in which the abnormality monitoring device 10 is not mounted on the vehicle as shown in FIG. 2, the description of each embodiment will be cited because the description is the same as each embodiment except that a communication method with the electronic control unit 20 is different.

Here, the “mobile object” refers to a movable object, and a movement speed may be arbitrary. A case where the mobile object is stopped is also included. Examples of the moving object include, but are not limited to, an automobile, a motorcycle, a bicycle, a pedestrian, a ship, an aircraft, and an object mounted thereon.

The term “mounted” includes not only a case where an object is directly fixed to the moving object but also a case where an object is moved together with the moving object although the object is not fixed to the mobile object. Examples of the object include an object carried by a user who is in the moving object and an object attached to a load carried by the mobile object.

The abnormality monitoring device 10 is a device that monitors abnormalities in the electronic control system S and “reports” the abnormalities to a center device 30. The abnormality monitoring device 10 is implemented by one or more electronic control units that constitute the electronic control system S as shown in FIG. 1, but may also be provided outside the electronic control system S and connected to the electronic control system S.

Here, “reporting” means to give some kind of notification to the center device as the abnormality monitoring result. It also includes transmitting the monitoring target to a center device.

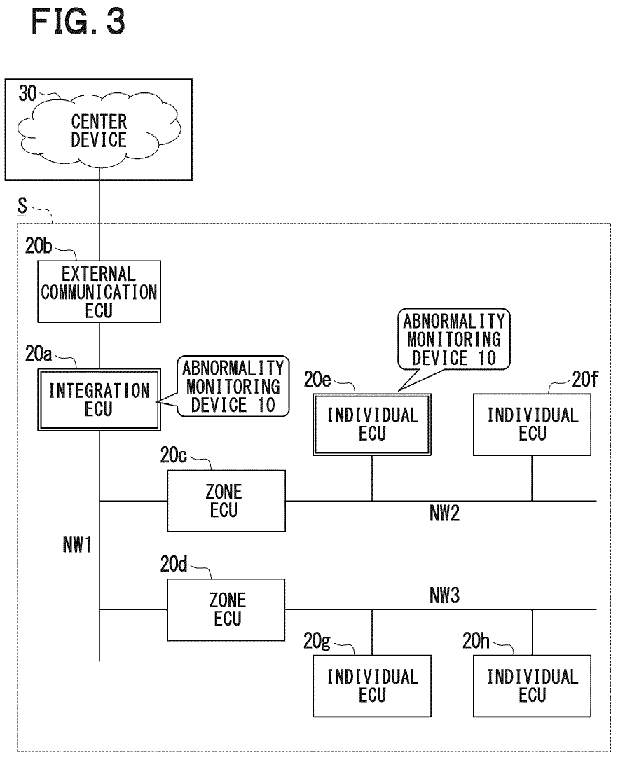

The electronic control unit (ECU: Electric Control Unit, hereinafter referred to as ECU) 20 is a device that constitutes the electronic control system S. An example of the configuration of the electronic control system S and the ECU 20 will be described later with reference to FIG. 3.

The center device 30 is placed outside the mobile object and receives reports from the abnormality monitoring device 10. An example of the center device 30 is a Security Operations Center (SOC) that receives security logs from the abnormality monitoring device 10 and detects and analyzes cyber attacks.

In FIG. 1, the abnormality monitoring device 10 and the center device 30 are connected via a communication network using a wireless communication system such as IEEE 802.11 (Wi-Fi (registered trademark)), IEEE 802.16 (WiMAX (registered trademark)), wideband code division multiple access (W-CDMA), high speed packet access (HSPA), long term evolution (LTE), long term evolution advanced (LTE-A), 4G, or 5G. Alternatively, dedicated short range communication (DSRC) can be used. When the vehicle is parked in a parking lot or accommodated in a repair shop, a wired communication method can be used instead of the wireless communication method. For example, a local area network (LAN), the Internet, or a fixed telephone line may be used.

In addition, a line combining the wireless communication system and the wired communication system may be used. For example, the abnormality monitoring device 10 and a base station device in a cellular system may be connected to each other via the wireless communication system such as 4G, and the base station device and the center device 30 may be connected to each other via the wired communication system such as a core line of a communication carrier or the Internet. A gateway device may be provided at a point of contact between the backbone line and the Internet.

In FIG. 1, the abnormality monitoring device 10 and the ECU 20 are connected to each other via an in-vehicle communication network such as, for example, a CAN (Controller Area Network) or a LIN (Local Interconnect Network). Alternatively, the abnormality monitoring device 10 and the ECU 20 may be connected via any communication method, whether wired or wireless, such as Ethernet (registered trademark), Wi-Fi (registered trademark), or Bluetooth (registered trademark). The term “connection” refers to a state in which data can be exchanged. This state includes a case in which different hardware devices are connected through a wired or wireless communication network, as well as a case in which virtual machines running on the same hardware are virtually connected with one another.

In FIG. 2, the electronic control system S and the abnormality monitoring device 10 or the like provided outside the vehicle are also connected via a communication network using the wireless communication system or the wired communication system described above. The abnormality monitoring device 10 and the center device 30 are usually connected by a wired communication method, but may be connected by a wireless communication method.

In each embodiment, a vehicle system equipped to a vehicle will be described as an example of the electronic control system S. However, the electronic control system S is not limited to a vehicle system, and may be applied to any kind of electronic control system including a plurality of ECUs. For example, the electronic control system S may be equipped to a stationary object or a fixed object instead of a mobile object.

### (2) Configuration of Electronic Control System

FIG. 3 is a diagram illustrating a configuration example of the electronic control system S. The electronic control system S includes the plurality of ECUs 20 and in-vehicle networks NW1, NW2, NW3 for connecting the plurality of ECUs 20. Although FIG. 3 illustrates eight ECUs (ECUs 20a to 20h), it is obvious that the electronic control system S may include any number of ECUs. In the following description, the ECU 20 and the ECUs 20 are described comprehensively for a single or multiple electronic control units, and the ECU 20a, ECU 20b, ECU 20c, . . . are described when individual electronic control units are specifically described.

The in-vehicle networks (NW1 to NW3) use the in-vehicle communication network described in the description of FIG. 1.

The electronic control system S shown in FIG. 3 includes an integration ECU 20a, an external communication ECU 20b, zone ECUs 20c, 20d, and individual ECUs 20e, 20f, 20g, 20h.

The integration ECU 20a is an ECU having a function of controlling the entire electronic control system S and a gateway function of mediating communication among the ECUs 20. The integration ECU 20a may be referred to as a gateway ECU (G-ECU) or a mobility computer (MC). The integration ECU 20a may be a relay device or a gateway device.

The external communication ECU 20b includes a communication unit that communicates with an external device located outside the vehicle, for example, the center device 30 to be described in each embodiment. A communication method used by the external communication ECU 20b is the wireless communication method or the wired communication method described with reference to FIG. 1.

In order to implement a plurality of communication methods, the electronic control system S may include the plurality of external communication ECUs 20b. Instead of providing the external communication ECU 20b, the integration ECU 20a may have a function of the external communication ECU 20b.

Each zone ECU 20c, 20d has a gateway function provided according to a function or a location where each individual ECU 20e to 20h is arranged. The individual ECUs will be described later. For example, the zone ECU 20c has a gateway function of relaying communication between the individual ECU 20e, 20f disposed in a front region of the vehicle and another ECU 20. The zone ECU 20d has a gateway function of relaying communication between the individual ECU 20g, 20h disposed in a rear region of the vehicle and another ECU 20. The zone ECUs 20c, 20d may be referred to as domain computers (DC). The individual ECU 20e and the individual ECU 20f are connected to the zone ECU 20c via the network 2 (NW2). The individual ECU 20g and the individual ECU 20h are connected to the zone ECU 20d via a network 3 (NW3).

The individual ECUs 20e, 20f, 20g, 20h can be implemented by ECUs having any function. Examples of individual ECUs include a drive system electronic control unit that controls an engine, a steering wheel, a brake, and the like, a vehicle body system electronic control unit that controls a meter, a power window, and the like, an information system electronic control unit such as a navigation device, and a safety control system electronic control unit that performs control for preventing a collision with an obstacle or a pedestrian. The ECUs may be classified into a master and a slave instead of parallel arrangement.

In addition, necessary sensors may be connected to each of the individual ECUs 20e, 20f, 20g, 20h depending on the functions provided by each individual ECU. Examples of the sensor include, but are not limited to, a speed sensor, an acceleration sensor, an angular velocity sensor, a temperature sensor, a seat sensor, and a voltmeter. These sensors may be connected to the integration ECU 20a or the zone ECUs 20c, 20d instead of to the individual ECUs 20e, 20f, 20g, 20h.

Each ECU 20 may be a physically independent electronic control unit, or may be a virtual electronic control unit implemented by using a virtualization technology. When the ECUs 20 are implemented on different hardware, the ECUs 20 may be connected via a wired or wireless communication method. When a plurality of electronic control units are implemented in virtual manner using the virtualization technology on a single hardware, the virtual ECUs may be connected with one another in virtual manner.

In the case of FIG. 1, the abnormality monitoring device 10 is provided inside the electronic control system S. For example, as shown in FIG. 3, the abnormality monitoring device 10 may be implemented by the integration ECU 20a or by the individual ECU 20e. When the abnormality monitoring device 10 is implemented by the individual ECU 20e, the individual ECU 20e may be an ECU having dedicated purpose as the abnormality monitoring device 10. In an embodiment described later, the abnormality monitoring device 10 is implemented by the integration ECU 20a and the external communication ECU 20b.

Each ECU 20 has a security sensor. When the security sensor detects an abnormality occurrence in the ECU 20 or in the network connected to the ECU 20, the security sensor generates a security log. Details of security logs will be explained later.

It is not necessary for all the ECUs 20 to be equipped with a security sensor.

Further, when the ECUs 20 are connected to a network using a CAN, each ECU 20 is equipped with a CAN transceiver and a CAN controller. Each ECU 20 transmits and receives data using a predetermined communication frame. A communication frame includes an ID for identifying the frame.

Alternatively, when the ECUs 20 are connected to a network using Ethernet, the ECUs 20 transmit and receive data using frames having a predetermined frame format. The frame contains a destination address and a source address.

### (3) Details of Security Log

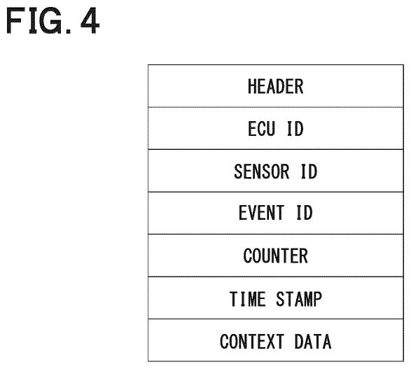

FIG. 4 is a diagram showing contents of a security log generated by the security sensor of the ECU 20.

The security log has the following data fields: an ECU ID indicating identification information of the ECU in which the security sensor is installed; a sensor ID indicating identification information of a target monitored by the security sensor; an event ID indicating identification information of an event related to an abnormality detected by the security sensor; a counter indicating the number of times the event has occurred; a timestamp indicating occurrence time of the event; and context data indicating details of the security sensor output. The security log may further include a header storing information indicating a protocol version and a state of each data field.

According to the specifications defined by AUTOSAR (AUTomotive Open System ARchitecture), IdsM Instance ID defined in AUTOSAR corresponds to ECU ID, Sensor Instance ID defined in AUTOSAR corresponds to the sensor ID, Event Definition ID defined in AUTOSAR corresponds to the event ID, Count defined in AUTOSAR corresponds to the counter, Timestamp defined in AUTOSAR corresponds to the timestamp, Context Data defined in AUTOSAR corresponds to the context data, Protocol Version and Protocol Header defined in AUTOSAR correspond to the header, respectively.

FIG. 4 shows a security log generated by a physically independent ECU 20. The security log may be generated by a virtual ECU.

The security log generated by the security sensor is represented as SEv, and a refined and accurate security log is represented by QSEv. For example, the security sensor of the individual ECU 20e, 20f, 20g, 20h shown in FIG. 3 generates security log SEv and reports it to an intrusion detection system manager (IdsM), which is not shown. When the security log SEv passes a certification filter and meets specified criteria in the IdsM, the security log SEv is transmitted as QSEv from an intrusion detection reporter to the outside of the vehicle. The security log in the embodiments is a concept including both the SEv and the QSEv.

The security log in each embodiment may be a log generated by a function known as in-vehicle Security Information and Event Management (SIEM). SIEM collects and manages information related to events occurred in the electronic control system.

### 2. First Embodiment

### (1) Configuration of Abnormality Monitoring Device

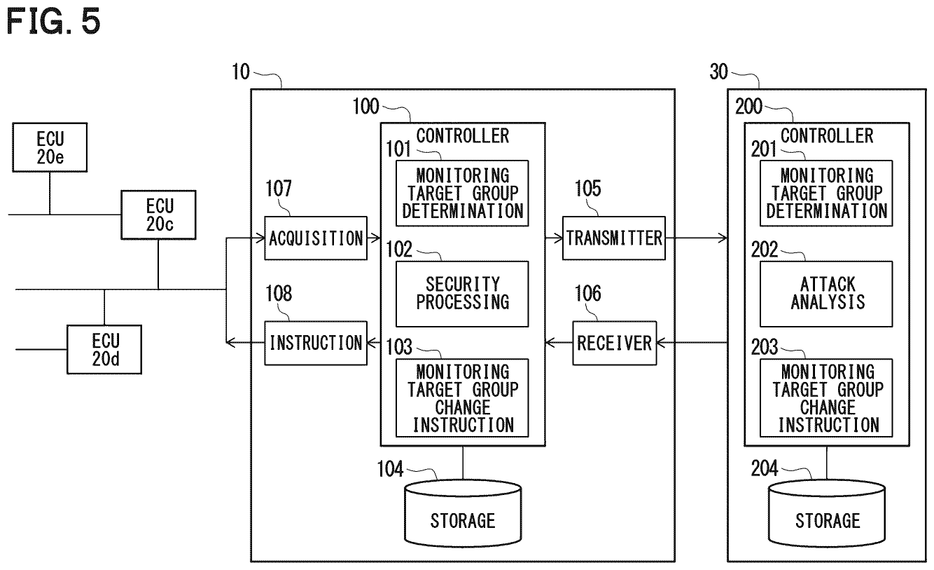

FIG. 5 is a block diagram showing the configuration of the abnormality monitoring device 10 and the center device 30 in the present embodiment. The abnormality monitoring device 10 includes a controller 100, a storage 104, a transmitter 105, a receiver 106, an acquisition unit 107, and an instruction unit 108. The controller 100 implements a monitoring target group determination unit 101, a security processing unit 102, and a monitoring target group change instruction unit 103 by hardware and/or software.

The abnormality monitoring device 10 can be implemented by a general-purpose central processing unit (CPU), a volatile memory such as a RAM, a non-volatile memory such as a ROM, a flash memory, or a hard disk, various interfaces, and an internal bus connecting these. By executing software on the hardware, functions of the functional blocks illustrated in FIG. 5 can be implemented.

Of course, the abnormality monitoring device 10 may be implemented by dedicated hardware such as an LSI.

The above also applies to the center device 30 and each ECU 20.

The transmitter 105 and the receiver 106 communicate with the center device 30.

The transmitter 105 transmits the detection result of an abnormality in the electronic control system S to the center device 30. In addition, in the present embodiment, the center device 30 transmits a security log, the trip number (corresponding to a “counter value”), which is the number of times the vehicle has been activated, information indicating that the IG is ON when the vehicle is activated (corresponding to “information indicating a vehicle operation status”), a monitoring target change notification indicating that the change of monitoring target has been completed, and other information required by the center device 30.

The receiver 106 receives various instructions from the center device 30. In the present embodiment, for example, a monitoring target change instruction, which is an instruction to change the monitoring target, is received.

The acquisition unit 107 and the instruction unit 108 communicate with each ECU 20 that constitutes the electronic control system S.

The acquisition unit 107 acquires the CAN or Ethernet frames and the security log by receiving them from each ECU 20.

The instruction unit 108 transmits instructions to each ECU 20. In the present embodiment, for example, an instruction is transmitted to the ECU 20 that is a monitoring target included in a monitoring target group determined by the monitoring target group determination unit 101 described later. The contents of the instruction include, for example, an instruction to perform or not perform message authentication and intrusion detection for CAN frames, an instruction to operate or not operate a security sensor, and an instruction to generate or not generate a security log.

The storage 104 stores information received from each ECU 20, information generated by the abnormality monitoring device 10, information used by the abnormality monitoring device 10, and information received from the center device 30.

In the present embodiment, in particular, a monitoring target group list is stored. The monitoring target group list will be described in detail later.

The storage 104 may be an external storage device (hard disk, USB memory, CD/BD, or the like) or an internal storage device (RAM, or the like). It may also be volatile or non-volatile. The same applies to a storage 204 described below.

The monitoring target group determination unit 101 determines a monitoring target group (corresponding to a “first monitoring target group”), which is a set including a part of all monitoring target candidates in the electronic control system S, “based” on identification information (corresponding to “first identification information”) that is “synchronized” between the abnormality monitoring device 10 and the center device 30.

Here, the expression of “synchronized” means that the same information is shared between the abnormality monitoring device and the center device at a specific point in time, and the method of sharing is not important. That is, one device may transmit information to the other device to share the same information, or each device may generate and share the same information by applying the same rules. Also, it is sufficient to be able to share information at a specific point in time, and it is not necessary to be able to share at all times.

The expression of “based on” includes not only direct use of the first identification information but also indirect use of the first identification information. That is, this also includes the case where information obtained by performing a predetermined calculation or conversion on the first identification information is used.

First, in this embodiment, the identification information is a value obtained by connecting upper bits and lower bits, with the vehicle identifier. The vehicle identifier unique to the vehicle in which the abnormality monitoring device 10 is installed is set as the upper bits, and the trip number, which is the number of times the vehicle has been activated, is set as the lower bits.
Identification information=vehicle identifier (+) trip number: ((+) is an operator that indicates connection)

Then, the identification information is input and a hash value is calculated using a hash function.
Hash value=h (identification information): (h(x) is a hash function with x as input)

The hash value is a fixed length value of, for example, 255 bits.

The vehicle identifier is shared in advance between the abnormality monitoring device 10 and the center device 30. In addition, the trip number is shared by transmitting the current trip number from the abnormality monitoring device 10 to the center device 30. Since both the vehicle identifier and the trip number can be shared between the abnormality monitoring device 10 and the center device 30, it can be said that the identification information is synchronized between the two devices.

Since the vehicle identifier is preset in the vehicle and the center device 30, there is no need to transmit and receive the vehicle identifier between the vehicle and the center device 30, and the risk of the vehicle identifier being leaked is low.

Further, since the trip number changes depending on the usage situation of the vehicle, by combining the vehicle identifier and the trip number, it is possible to reduce the risk of leakage and a constantly changing value.

A value obtained by combining the vehicle identifier and the trip number is used as identification information, and the hash value is calculated from this identification information, so that a completely different hash value can be obtained each time the hash value is calculated. As a result, the monitoring target group can be determined randomly.

It should be noted that information indicating the start of a trip (corresponding to “information indicating the operation status of the vehicle”), for example, information indicating IG ON, may be transmitted from the abnormality monitoring device 10 to the center device 30 each time the trip starts, instead of transmitting the trip number (corresponding to a “counter value”) from the abnormality monitoring device 10 to the center device 30, and the abnormality monitoring device 10 and the center device 30 may each count and accumulate the number of times IG ON is turned on.

By sharing the trip count between the abnormality monitoring device 10 and the center device 30 in this manner, there is no need to transmit the trip count itself from the abnormality monitoring device 10 to the center device 30, and there is little risk of the trip being leaked. Therefore, it is possible to further improve the confidentiality of the identification information.

Next, in the present embodiment, each ECU 20 is considered as a monitoring target candidate. As shown in FIG. 3, in this embodiment, the electronic control system S includes eight ECUs 20, namely, ECUs 20a to 20h, and therefore all eight ECUs 20 are the monitoring target candidates. Then, a set of some of the monitoring targets among all the monitoring target candidates becomes the monitoring target group.

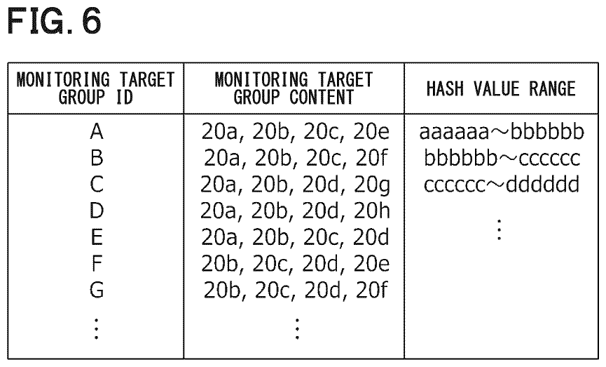

FIG. 6 is an example of a monitoring target group list in which a monitoring target group including a plurality of monitoring target candidates is listed. The monitoring target group list is stored in the storage 104. In the monitoring target group list of FIG. 6, the first column is a monitoring target group ID, the second column is the content of the monitoring target group, and the third column is the range of the hash value. For example, the monitoring target group indicated by the monitoring target group ID A includes ECU 20a, ECU 20b, ECU 20c, and ECU 20e. That is, a monitoring target group A is defined as a set of four monitoring target candidates which are a part of the total eight monitoring target candidates. The same applies to a monitoring target groups B and onward.

In the monitoring target group list of FIG. 6, the number of monitoring target candidates is always four, but the number of monitoring target candidates may be varied. For example, there may be a mixture of combinations of six, five, and four monitoring target candidates. For example, the fewer the remaining resources of the abnormality monitoring device 10, the fewer monitoring target candidates are included in the monitoring target group that is selected.

Further, in the monitoring target group list of FIG. 6, the ECUs 20 are selected as monitoring target candidates with the same probability regardless of the type of ECU 20, but the probability that important ECUs 20 are included may be increased. For example, the integration ECU 20a may set the probability to 100%. That is, the integration ECU 20a may be included in every monitoring target group. In this way, the more important the ECU 20, the longer the monitoring time can be.

The monitoring target group determination unit 101 determines the monitoring target group ID corresponding to the hash value calculated from the identification information. For example, when the obtained hash value is within the range of cccccc to dddddd, the monitoring target group ID is determined to be C.

Then, the monitoring target group determination unit 101 notifies the security processing unit 102 of the monitoring target group ID determined by the monitoring target group determination unit 101. Furthermore, the monitoring target group determination unit 101 may instruct the instruction unit 108 on the operation that the ECUs 20 included in the monitoring target group determined by the monitoring target group determination unit 101 should serve as the monitoring target.

The instruction unit 108 instructs the ECUs 20 included in the monitoring target group determined by the monitoring target group determination unit 101 on the operation that they should serve as the monitoring target. In this embodiment, for example, ECUs 20 (ECU 20a, ECU 20b, ECU 20c, ECU 20e) included in the monitoring target group C are instructed to generate and transmit the generated security log, and ECUs 20 not included in the monitoring target group C are instructed not to generate and transmit the security log.

The instruction from the instruction unit 108 may be arbitrary. In this case, the security processing unit 102 may limit the processing targets to the ECUs 20 included in the monitoring target group.

The security processing unit 102 executes a process for ensuring the security for the monitoring targets included in the monitoring target group determined by the monitoring target group determination unit 101 (corresponding to the “first group of monitoring target”). In the present embodiment, processing is performed on the security log acquired by the acquisition unit 107. More specifically, for example, when the security log transmitted from the ECU 20 included in the monitoring target group C indicates an abnormality, the transmitter 105 is instructed to transmit the security log indicating the abnormality to the center device 30. Since the security logs are not received from ECUs 20 that are not included in the monitoring target group C, no specific process is required.

In addition, when no instructions are given to each ECU from the instruction unit 108, the security processing unit 102 only needs to process the security log transmitted from ECUs 20 included in the monitoring target group C, and does not process the security log transmitted from ECUs 20 that are not included in the monitoring target group C. The ECU 20 that has transmitted the security log may be identified, for example, by the ECU ID in the security log field of FIG. 3.

When the “predetermined condition” is satisfied, the monitoring target group change instruction unit 103 instructs the monitoring target group determination unit 101 to change the monitoring target group currently being monitored (corresponding to the “first monitoring target group”) to a different monitoring target group (corresponding to the “second monitoring target group”). The predetermined condition may be singular or plural. When the plurality of conditions are set, the monitoring target may be changed when the first condition and the second condition are simultaneously satisfied, or the monitoring target may be changed when the second condition is satisfied after the first condition is satisfied.

Here, the “predetermined condition” refers to a condition that has been determined in advance, and may be a constant condition or may change. For example, the length of the period, which is a predetermined condition, may be changed depending on the amount of security processing.

An example of the predetermined condition is when an instruction to change the monitoring target group is received from the center device 30. When the center device 30 receives the monitoring target group change instruction, the monitoring target group change instruction unit 103 instructs the monitoring target group determination unit 101 to change the monitoring target group.

In this case, since instructions from the center device 30 are set as the specified condition, the center device 30 can also change the monitoring target group at the same time, and the center device 30 can control the timing of changing the monitoring target of the abnormality monitoring device 10. For example, the center device 30 can flexibly change the monitoring target group based on the possibility of a cyber attack occurrence.

Other predetermined conditions may include the vehicle being stopped or parked. According to these conditions, it is possible to reduce the effect on vehicle travel caused by changing the monitoring target group.

### (2) Configuration of Center Device

FIG. 5 is a block diagram showing the configuration of the abnormality monitoring device 10 and the center device 30 in the present embodiment. The center device 30 includes a controller 200 and the storage 204. The controller 200 implements a monitoring target group determination unit 201, an attack analysis unit 202, and a monitoring target group change instruction unit 203 by hardware and/or software.

The monitoring target group determination unit 201 determines a monitoring target group (corresponding to the “first monitoring target group”), which is a set including a part of all monitoring target candidates in the electronic control system S, “based” on identification information (corresponding to the “first identification information”) that is “synchronized” between the abnormality monitoring device 10 and the center device 30.

The functions and operations of the monitoring target group determination unit 201 are the same as those of the monitoring target group determination unit 101 of the abnormality monitoring device 10.

In this way, the monitoring target group can be determined by using the same monitoring target group list based on the identification information synchronized with the abnormality monitoring device 10. Therefore, it is possible for the center device 30 to manage the monitoring objects of the abnormality monitoring device 10 without receiving notification of the monitoring target group from the abnormality monitoring device 10.

The attack analysis unit 202 analyzes cyber attacks based on reports from the abnormality monitoring device 10. In the present embodiment, the type and attack path of a cyber attack are analyzed using a security log indicating an abnormality transmitted from the transmitter 105 of the abnormality monitoring device 10.

When the “predetermined condition” is satisfied, the monitoring target group change instruction unit 203 instructs the monitoring target group determination unit 201 to change the monitoring target group currently being monitored (corresponding to the “first monitoring target group”) to a different monitoring target group (corresponding to the “second monitoring target group”). An example of the predetermined condition is that a certain amount of time has passed since the last time the monitoring target group was changed. When the center device 30 receives the monitoring target group change instruction, the monitoring target group change instruction unit 203 instructs the monitoring target group determination unit 201 to change the monitoring target group.

The functions and operations of the monitoring target group change instruction unit 203 are the same as the functions and operations of the monitoring target group change instruction unit 103 of the abnormality monitoring device 10.

In this way, since the monitoring target group can be changed in synchronization with the abnormality monitoring device 10, it is possible for the center device 30 to manage changes in the monitoring targets of the abnormality monitoring device 10.

The storage 204 stores information generated by the center device 30, information used by the center device 30, and information to be transmitted to the abnormality monitoring device 10.

In the present embodiment, in particular, the monitoring target group list is stored. The monitoring target group list stored in the storage 204 is the same as the monitoring target group list stored in the storage 104 of the abnormality monitoring device 10.

### (3) Operation of Abnormality Monitoring Device and Center Device

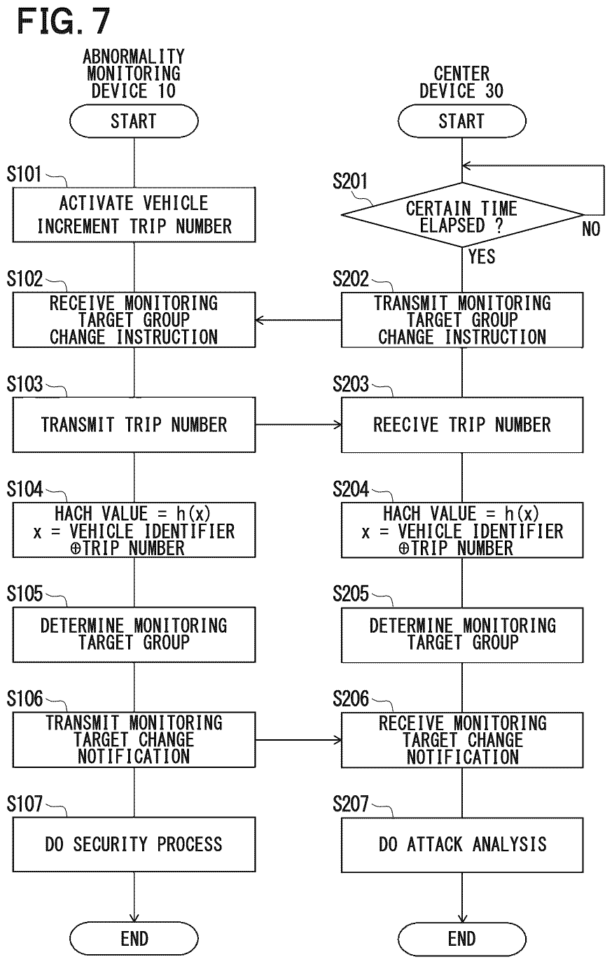

Next, the operation of the abnormality monitoring device 10 and the center device 30 will be described with reference to FIG. 7. FIG. 7 not only shows an abnormality monitoring method executed by the abnormality monitoring device 10, but also shows the processes of an abnormality monitoring program that can be executed by the abnormality monitoring device 10. Also, this not only shows the attack analysis method executed by the center device 30 but also shows the processing procedure of the attack analysis program that can be executed by the center device 30. These processes are not limited to the order illustrated in FIG. 7. That is, the order may be interchanged as long as there are no restrictions, such as a relationship in which one process uses the results of its prior process. The same applies to other embodiments.

The monitoring target group change instruction unit 203 of the center device 30 determines whether a certain time has elapsed since the previous change of the monitoring target group (S201). When the certain period of time has not elapsed (S201: No), the process returns to S201. When the certain period has elapsed (S201: Yes), the monitoring target group change instruction unit 203 transmits a monitoring target group change instruction to the abnormality monitoring device 10 (S202).

When the vehicle on which the abnormality monitoring device 10 is mounted is activated, the abnormality monitoring device 10 increments the trip number stored in the storage 104, and stores the incremented trip number in the storage 104 (S101).

The receiver 106 of the abnormality monitoring device 10 receives the monitoring target group change instruction from the center device 30 (S102). Then, the monitoring target group change instruction unit 103 instructs the transmitter 105 to transmit the trip number (corresponding to a “counter value”) stored in the storage 104 to the center device 30 (S103), and also instructs the monitoring target group determination unit 101 to change the monitoring target group.

The center device 30 receives the trip number transmitted by the abnormality monitoring device 10 (S203).

The monitoring target group determination unit 101 of the abnormality monitoring device 10 receives, as input, the identification information having a vehicle identifier as the upper bits and the trip number as the lower bits, and obtains the hash value using the hash function (S104). The vehicle identifier is read out from the value stored in advance in the storage 104. Also, the trip number is read out from the storage 104.

Next, the monitoring target group determination unit 101 uses the monitoring target group list stored in the storage 104 to determine the monitoring target group corresponding to the hash value obtained in S104 (S105).

Then, the transmitter 105 transmits a monitoring target group change notification indicating that the monitoring target group has been changed to the center device 30 (S106).

Thereafter, the security processing unit 102 executes a process for ensuring security for the monitoring target group determined in S105 (S107).

On the other hand, the monitoring target group determination unit 201 of the center device 30 receives, as input, the identification information having a vehicle identifier as the upper bits and the trip number as the lower bits, and obtains the hash value using the hash function (S204). The vehicle identifier is read out from the value stored in advance in the storage 204. The trip number is the value received in S203.

Next, the monitoring target group determination unit 201 uses the monitoring target group list stored in the storage 204 to determine the monitoring target group corresponding to the hash value obtained in S204 (S205).

Then, the center device 30 receives a notification of change of the monitoring target group from the abnormality monitoring device 10 (S206), and confirms that the abnormality monitoring device 10 has changed the monitoring target group.

Thereafter, the attack analysis unit 202 performs an analysis of the cyber attack based on the report from the abnormality monitoring device 10 (S207).

### (4) Other Examples of Monitoring Target Group List

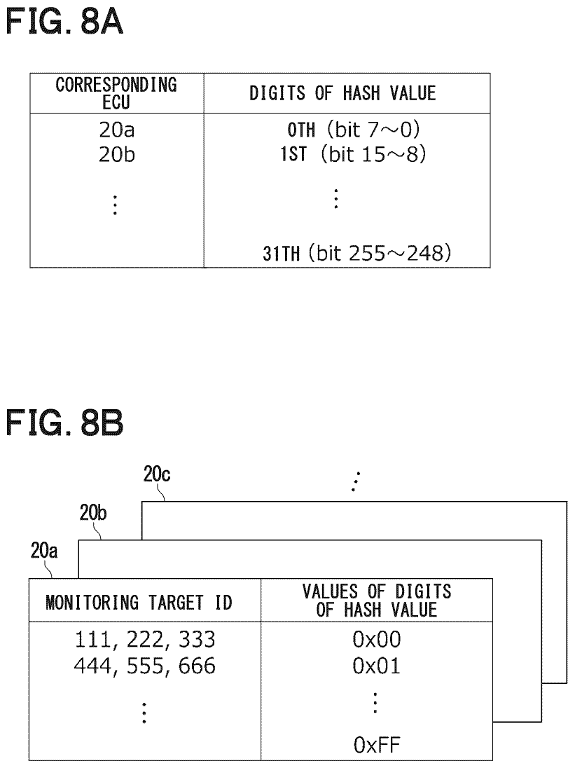

FIGS. 8A and 8B show another example of the monitoring target group list.

The monitoring target group list of FIGS. 8A and 8B is used when the monitoring target candidates are set in a unit other than each ECU 20. For example, the monitoring target candidates may be security sensors of each ECU 20, or types of security logs or event types generated by each ECU 20. In FIGS. 8A and 8B, these are all collectively referred to as monitoring target ID.

The monitoring target group list in FIGS. 8A and 8B includes one master table in FIG. 8A and a plurality of sub-tables in FIG. 8B.

In the master table of FIG. 8A, the first column indicates the corresponding ECU, and the second column indicates each digit of the hash value. In the present embodiment, the hash value is composed of 255 bits, and each 8-bit range is associated with each ECU 20.

The sub-table in FIG. 8B is provided for each ECU 20, with the first column indicating the monitoring target ID and the second column indicating the value of each digit of the hash value.

For example, when the zeroth digit (0th to 7th bits) of the hash value obtained by the monitoring target group determination unit 101 is 0×01, the monitoring targets are monitoring target IDs 444, 555, and 666 of the ECU 20a. By similarly associating the other digits of the hash value, the monitoring target ID of each ECU 20 can be determined.

### (5) Short Overview

As described above, according to the present embodiment, the process is executed to ensure the security for the monitoring target group, which is a partial set of all monitoring target candidates in the electronic control system S, so that it is possible to monitor the abnormality in the electronic control system S even when there are few resources available for abnormality monitoring. Further, even when sufficient resources can be allocated to abnormality monitoring, it is possible to allocate the surplus resources to other functions.

Furthermore, according to this embodiment, the monitoring target group is changed when a predetermined condition is satisfied, so that, from a medium to long-term perspective, it is possible to monitor all of the monitoring target candidates. This is because it is difficult for an attacker to identify the monitoring target, and therefore it can be said that the same level of security can be maintained as if all monitoring target candidates were monitored.

Furthermore, according to the present embodiment, the monitoring target group is determined using identification information that is synchronized between the abnormality monitoring device 10 and the center device 30, so that the monitoring target group can be changed at the same time in the abnormality monitoring device 10 and the center device 30. As a result, the center device 30 can manage the monitoring target without receiving a notification of the changed monitoring target from the abnormality monitoring device 10.

### 2. Second Embodiment

This embodiment differs from the first embodiment in the operation of the monitoring target group change instruction unit 103. Since the configuration of the abnormality monitoring device 10 of the present embodiment is the same as the configuration of the abnormality monitoring device 10 of the first embodiment, the description of the first embodiment and FIG. 5 will be cited.

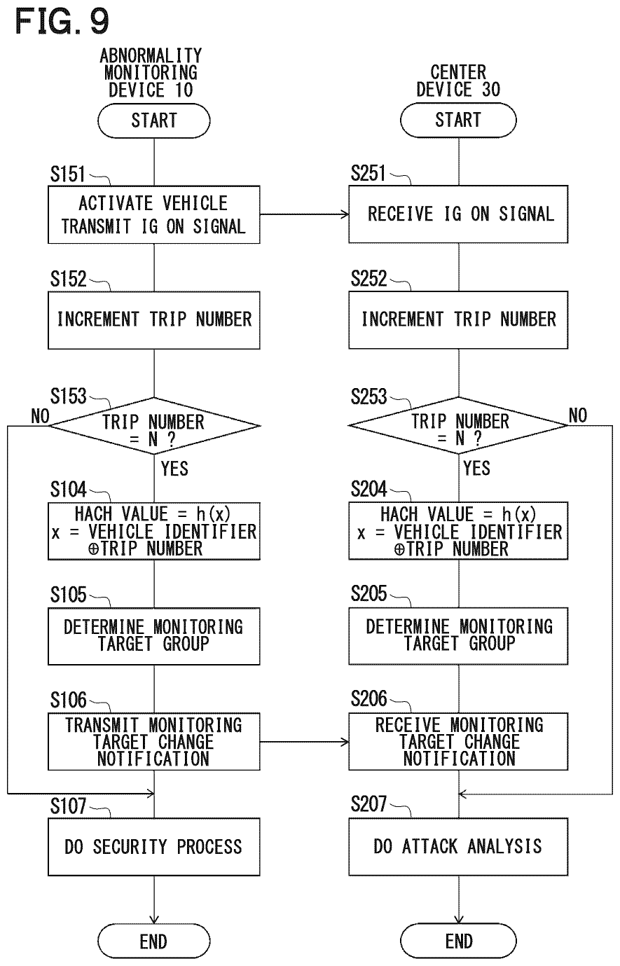

Hereinafter, the operation of the abnormality monitoring device 10 and the center device 30 of the present embodiment will be described with reference to FIG. 9.

The transmitter 105 of the abnormality monitoring device 10 transmits information indicating IG ON (corresponding to “information indicating the operation status of the vehicle”) to the center device 30 every time the vehicle is activated (S151). Then, the trip number stored in the storage 104 is incremented, and the incremented trip number is stored in the storage 104 (S152).

The center device 30 receives the information indicating IG ON transmitted from the abnormality monitoring device 10 (S251). Then, the trip number stored in the storage 204 is incremented, and the incremented trip number is stored in the storage 204 (S252).

The monitoring target group change instruction unit 103 of the abnormality monitoring device 10 determines whether the trip number (corresponding to the “counter value”) is a predetermined value N (S153). When the trip number is not N (S153: No), the process ends. When the trip number is N (S153: Yes), the monitoring target group change instruction unit 103 instructs the monitoring target group determination unit 101 to change the monitoring target group.

For example, when N is set to 5, the monitoring target group is changed every five activations of the vehicle. Alternatively, when N is set to 1, the monitoring target group can be changed every time the trip starts. It is desirable to reset the trip number when the monitoring target group is changed.

The monitoring target group change instruction unit 203 of the center device 30, like the monitoring target group change instruction unit 103 of the abnormality monitoring device 10, also determines whether the trip number (corresponding to the “counter value”) is the predetermined value N (S253). When the trip number is not N (S253: No), the process ends. When the trip number is N (S253: Yes), the monitoring target group change instruction unit 203 instructs the monitoring target group determination unit 201 to change the monitoring target group.

The subsequent processes by the abnormality monitoring device 10 and the center device 30 are similar to that in the first embodiment, so the same process numbers as in the first embodiment are used and the description of the first embodiment is cited.

In the present embodiment, although the abnormality monitoring device 10 transmits information indicating that the IG is ON to the center device 30, any signal that can be used to infer that the vehicle has started to trip suffices.

As described above, according to the present embodiment, in addition to the effects described in the first embodiment, the information transmitted between the abnormality monitoring device 10 and the center device 30 is information indicating that the IG is ON. Therefore, it is difficult for an external party to know the timing and conditions for changing the monitoring target group, and a highly confidential process for changing the monitoring target group can be executed.

### 3. Modifications of Each Embodiment

The monitoring target group determination unit 101, the security processing unit 102, and the monitoring target group change instruction unit 103 in the first and second embodiments (hereinafter referred to as each embodiment) can be modified in configuration according to the purpose or use.

### (1) Monitoring Target Group Determination Unit

### (a) Identification Information

In each embodiment, a value obtained by combining the vehicle identifier and the trip number is used as the identification information. However, any information that is synchronized with the center device 30 may be used.

For example, the counter value that increases or decreases depending on the operation status of the vehicle may be used as the identification information. Examples of the counter value include, in addition to a value that combines the vehicle identifier and trip number used in the first and second embodiments, the trip number alone, the number of times the parking brake has been turned on, and a message counter value that increases or decreases each time a specific message, such as a specific CAN communication frame, is transmitted or received.

An example of the identification information that is not related to the operation status of the vehicle is a time counter value that increases or decreases over time.

An example of identification information other than the counter value is information included in a CAN communication frame when the communication frame is transmitted to the center device 30.

In the first embodiment, the identification information itself is transmitted from the abnormality monitoring device 10 to the center device 30. In the second embodiment, the identification information itself is not transmitted, but information required for generating the identification information is transmitted from the abnormality monitoring device 10 to the center device 30. Thereby, the identification information is generated by each device.

An example of information required to generate the identification information is information indicating the operation status of the vehicle. Examples of this information include information indicating that the IG is ON and information indicating that the parking brake is ON.

In addition, when using a time counter value, each of the abnormality monitoring device 10 and the center device 30 may have a time counter, and the time counters may be synchronized with each other. Synchronization may be achieved by one device transmitting the time counter value to the other device.

Also, in each embodiment, although the identification information is input and a hash value is calculated using a hash function, it is not always necessary to use the hash function. When the hash function is not used, the monitoring target group list in FIG. 6 may use a range of identification information instead of the range of hash values in the third column.

### (b) Monitoring Target

In each embodiment, the electronic control unit, that is, each ECU 20, is set to the monitoring target. However, another device may be set to the monitoring target. For example, a security sensor mounted in each ECU 20 or a security log generated by the security sensor may be set as the monitoring target. In the former case, for example, the sensor ID in the security log field in FIG. 3 can be used to identify whether the device is the monitoring target. In the latter case, the event ID can be used to identify whether the device is the monitoring target.

Alternatively, the monitoring target may be a CAN communication frame or an Ethernet frame. In this case, whether the device is the monitoring target may be identified based on an ID included in a CAN communication frame or a destination address or a transmission source address included in an Ethernet frame.

### (c) Instructions from Instruction Unit

In each embodiment, the monitoring targets included in the monitoring target group are electronic control units, that is, the ECUs 20. The instruction unit 108 instructs each ECU 20 that is the monitoring target to generate and transmit a generated security log, and instructs each ECU 20 that is not the monitoring target not to generate and transmit the security log. Even when the monitoring target group is the security sensors or security logs as described above, the instruction unit 108 may instruct each ECU 20 that generates and transmits the security sensors or the security logs included in the monitoring target group as to whether to generate and transmit them. Alternatively, it may be instructed whether to operate the security sensor.

Furthermore, when the monitoring target is a CAN communication frame or an Ethernet frame, the instruction unit 108 may provide instructions indicating whether message authentication is required for the communication frame or whether intrusion detection is required.

### (d) Others

The monitoring target group list used by the monitoring target group determination unit 101 may continue to use the same one when the monitoring target group is changed, but may also be changed as appropriate. For example, the monitoring target group list may be changed every time, periodically, or irregularly by changing the monitoring target group list itself, by swapping the range of hash values within the same list, or by changing the hash function.

### (e) Others

The above (a), (b), and (d) can also be applied to the monitoring target group determination unit 201 of the center device 30.

### (2) Security Processing Unit

In each embodiment, the monitoring target included in the monitoring target group is an electronic control unit, that is, ECU 20, and when the security log transmitted from the monitoring target ECU 20 indicates the abnormality, the security processing unit 102 instructs the transmitter 105 to transmit the security log indicating the abnormality to the center device 30. Even in the case where the monitoring target group is the security sensor or the security log as described above, when the security log transmitted from the security sensor included in the monitoring target group indicates an abnormality, or when the security log included in the monitoring target group indicates an abnormality, the security processing unit 102 may instruct the transmitter 105 to transmit the security log indicating the abnormality to the center device 30.

Further, when the monitoring object is a CAN communication frame, the security processing unit 102 may detect the abnormality in the communication frame, and when the abnormality is detected, instruct the transmitter 105 to transmit the detection result to the center device 30. The similar applies to Ethernet frames.

### (3) Monitoring Target Group Change Instruction Unit

In the first embodiment, the predetermined condition is set to a case where monitoring target group change instruction is received from the center device 30. In the second embodiment, the predetermined condition is the trip number. However, other conditions may be used.

For example, the predetermined condition may be a predetermined time or the passage of a certain period. In this case, when the abnormality monitoring device 10 and the center device 30 each have a timing means, the abnormality monitoring device 10 and the center device 30 can each determine whether the conditions are met without requiring information from the other device.

The predetermined conditions in the first embodiment can also be applied to the monitoring target group change instruction unit 203 of the center device 30. In other words, the predetermined condition may be a case in which the monitoring target group change instruction unit 203 of the center device 30 receives an instruction to change the monitoring target group from the abnormality monitoring device 10. In this case, the trigger for changing the monitoring target group is provided by the abnormality monitoring device 10 for the vehicle.

### 4. General Overview

The features of the abnormality monitoring device or the like according to each embodiment of the present disclosure have been described above.

Since terms used in the embodiments are examples, the terms may be replaced with synonymous terms or terms including synonymous functions.

The block diagrams used for the description of the embodiments are obtained by classifying and organizing the configuration of each device for each function. The blocks representing the respective functions may be implemented by any combination of hardware or software. Since the blocks represent the functions, such a block diagram may also be understood as disclosures of a method and a program for implementing the method.

An order of functional blocks that can be understood as processes, flows, and methods described in the embodiments may be changed as long as there are no restrictions such as a relation in which results of preceding processes are used in one other process.

The terms such as first, second, to N-th (where N is an integer) used in each embodiment and in the claims are used to distinguish two or more configurations and methods of the same kind and are not intended to limit the order or superiority.

Embodiments of the abnormality monitoring device and the center device of the present disclosure may be configured as a component, a semi-finished product, a finished product or the like.

Examples of component include a semiconductor element, an electronic circuit, a module, and a microcomputer.

Examples of a form of a semi-finished product include an electric control unit (ECU) and a system board.

Examples of a form of a finished product include a cellular phone, a smartphone, a tablet computer, a personal computer (PC), a workstation, and a server.

Other examples of the present disclosure may include a device having communication function, such as a video camera, a still camera, or a car navigation system.

Necessary functions such as an antenna or a communication interface may be added to the abnormality monitoring device.

The center device according to the present disclosure may be used for the purpose of providing various services, especially when used on the server side. With the provision of such services, the center device of the present disclosure is used, the method of the present is used, and the program of the present disclosure is executed.

The present disclosure may be implemented by not only dedicated hardware having the configurations and functions described in each embodiment but also as a combination of a program recorded in a storage medium such as a memory or a hard disk and provided to implement the present disclosure, and general-purpose hardware having a dedicated or general-purpose CPU, which can execute the program, and having a memory and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. Thereby, the latest functions can be provided at all times through program upgrade.

### INDUSTRIAL APPLICABILITY

The abnormality monitoring device of the present disclosure is primarily intended to detect abnormalities in electronic control systems mounted on automobiles, but may also detect abnormalities in ordinary systems that are not mounted on automobiles.

Here, the process of the flowchart or the flowchart described in this application includes a plurality of sections (or steps), and each section is expressed as, for example, S101. Further, each section may be divided into several subsections, while several sections may be combined into one section. Furthermore, each section thus configured may be referred to as a device, module, or means.

The controller and method described in the present disclosure may be implemented by a special purpose computer created by configuring a memory and a processor programmed to execute one or more particular functions embodied in computer programs. Alternatively, the controller and method described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

What is claimed is:

1. An abnormality monitoring device that monitors an abnormality in an electronic control system mounted on a mobile object and reports the abnormality to a center device, the abnormality monitoring device comprising:
a monitoring target group determination unit configured to determine a first monitoring target group, which is a set including a part of all of a monitoring target candidate in the electronic control system, based on first identification information synchronized between the abnormality monitoring device and the center device; and
a security processing unit configured to execute a process to ensure security on the first monitoring target group.

2. The abnormality monitoring device according to claim 1, wherein
the first identification information includes a counter value that increases or decreases depending on an operation status of a vehicle that is the mobile object.

3. The abnormality monitoring device according to claim 2, wherein
by transmitting the counter value to the center device, the first identification information is shared between the center device and the counter value.

4. The abnormality monitoring device according to claim 2, wherein
the first identification information is shared with the center device by transmitting information indicating the operation status of the vehicle to the center device.

5. The abnormality monitoring device according to claim 2, wherein
the counter value is a trip number, which is a numeral number of times the vehicle has been activated.

6. The abnormality monitoring device according to claim 4, wherein
the counter value is a trip number, which is a numeral number of times the vehicle has been activated, and
when the vehicle is activated, information indicating a trip start is transmitted to the center device to share the first identification information with the center device.

7. The abnormality monitoring device according to claim 2, wherein
the counter value is a message counter value that increases or decreases each time a specific message is transmitted or received.

8. The abnormality monitoring device according to claim 1, wherein
the first identification information is a time counter value that increases or decreases over time.

9. The abnormality monitoring device according to claim 1, further comprising
a storage configured to store a monitoring target group list that lists a monitoring target group including the monitoring target candidate that is a plurality of monitoring target candidates,
wherein
the monitoring target group determination unit is configured to determine, based on a hash value calculated from the first identification information, the monitoring target group corresponding to the hash value as the first monitoring target group.

10. The abnormality monitoring device according to claim 1, wherein
the monitoring target candidate is an electronic control unit constituting the electronic control system, and
the security processing unit detects an abnormality in the electronic control unit, and provides an instruction for transmitting a detection result to the center device when the abnormality is detected.

11. The abnormality monitoring device according to claim 1, wherein
the monitoring target candidate is a controller area network (CAN) communication frame generated by an electronic control unit constituting the electronic control system, and
the security processing unit detects an abnormality in the communication frame, and provides an instruction for transmitting a detection result to the center device when the abnormality is detected.

12. The abnormality monitoring device according to claim 1, wherein
the monitoring target candidate is a security sensor of an electronic control unit constituting the electronic control system, and
the security processing unit provides an instruction for transmitting a security log to the center device when the security log generated by the security sensor indicates an abnormality.

13. The abnormality monitoring device according to claim 1, wherein
the monitoring target candidate is a security log generated by a security sensor of an electronic control unit constituting the electronic control system, and
the security processing unit provides an instruction for transmitting the security log to the center device when the security log indicates an abnormality.

14. The abnormality monitoring device according to claim 1, further comprising
a monitoring target group change instruction unit configured to instruct the monitoring target group determination unit to change the first monitoring target group to a second monitoring target group different from the first monitoring target group when a predetermined condition is satisfied.

15. The abnormality monitoring device according to claim 14, wherein
the predetermined condition is that an instruction to change a monitoring target is received from the center device.

16. The abnormality monitoring device according to claim 14, wherein
the predetermined condition is that a certain time has elapsed since a previous change of the monitoring target group.

17. The abnormality monitoring device according to claim 14, wherein
the first identification information includes a counter value that increases or decreases depending on an operation status of a vehicle that is the mobile object, and
the predetermined condition is that the counter value has reached a predetermined value.

18. The abnormality monitoring device according to claim 14, wherein
the predetermined condition is that an N-th trip has started since a previous change of the monitoring target group, and
N of the N-th trip is an integer equal to or greater than one.

19. The abnormality monitoring device according to claim 1, wherein
the abnormality monitoring device is mounted on the mobile object.

20. The abnormality monitoring device according to claim 1, wherein
the abnormality monitoring device is mounted outside the mobile object.

21. A center device that is mounted outside a mobile object and receives a report from an abnormality monitoring device for monitoring an abnormality in an electronic control system mounted on the mobile object, the center device comprising:
a monitoring target group determination unit configured to determine a first monitoring target group, which is a set including a part of all of a monitoring target candidate in the electronic control system, based on first identification information synchronized between the abnormality monitoring device and the center device; and
an attack analysis unit configured to analyze a cyber attack based on the report from the abnormality monitoring device.

22. The center device according to claim 21, comprising
a monitoring target group change instruction unit configured to instruct the monitoring target group determination unit to change the first monitoring target group to a second monitoring target group different from the first monitoring target group when a predetermined condition is satisfied.

23. An abnormality monitoring method executed by an abnormality monitoring device that monitors an abnormality in an electronic control system mounted on a mobile object and reports the abnormality to a center device, the abnormality monitoring method comprising:
determining a first monitoring target group, which is a set including a part of all of a monitoring target candidate in the electronic control system, based on first identification information synchronized between the abnormality monitoring device and the center device; and
executing a process to ensure security on the first monitoring target group.

24. The abnormality monitoring method according to claim 23, further comprising:
changing the first monitoring target group to a second monitoring target group different from the first monitoring target group when a predetermined condition is satisfied.

25. A non-transitory computer-readable storage medium storing an abnormality monitoring program executable by an abnormality monitoring device that monitors an abnormality in an electronic control system mounted on a mobile object and reports the abnormality to a center device, the abnormality monitoring program instructing the abnormality monitoring device to:
determine a first monitoring target group, which is a set including a part of all of a monitoring target candidate in the electronic control system, based on first identification information synchronized between the abnormality monitoring device and the center device; and
execute a process to ensure security on the first monitoring target group.

26. The non-transitory computer-readable storage medium storing the abnormality monitoring program according to claim 25, and the program further instructing the abnormality monitoring device to:
provide an instruction for changing the first monitoring target group to a second monitoring target group different from the first monitoring target group when a predetermined condition is satisfied.
